(19) United States
(12) Patent Application Publication
(10) Pub. No.: US 2025/0298664 A1
(43) Pub. Date: Sep. 25, 2025

(54) MICRO-SEGMENTATION WITHOUT INTERMEDIATE FIREWALL USING EBPF

(71) Applicant: Cisco Technology, Inc., San Jose, CA (US)

(72) Inventors: Andrew Zawadowskiy, Hollis, NH (US); Stephen Craig Connors, JR., Nashvile, TN (US); Vincent Parla, North Hampton, NH (US)

(21) Appl. No.: 18/611,453

(22) Filed: Mar. 20, 2024

(51) Int. Cl. G06F 9/50

(52) U.S. Cl. CPC G06F 9/5027

(57) ABSTRACT

Micro-segmentation without an intermediate firewall using an extended Berkeley Packet Filter (eBPF) is disclosed herein. This concept may identify one or more processes operating on a host network, assign a process identity to each process operating on the host network, monitor, by an eBPF, interactions between each of the processes operating on the host network, identify, by the eBPF, a source and a destination of the interactions between each of the processes, determine, by the eBPF, a first process operating on the host network does not interact with a second process operating on the host network based on the source and the destination of the first process and the second process, and block, by the eBPF, interactions between the first process and the second process.

### TECHNICAL FIELD

The present disclosure relates generally to systems, methods, and computer-readable media for performing micro-segmentation between two processes on the same host without an intermediate firewall, thereby separating the processes and enabling security controls to be enacted on those processes.

### BACKGROUND

Traditional micro-segmentation solutions require traffic to pass through an intermediate device (e.g., hypervisor, firewall, sidecar), and use the intermediate device to enforce east-west policies in terms of what VLANs or applications are allowed to communicate within the network. These traditional micro-segmentation solutions are used, for example, for separation of resources and enacting security protocols on those resources.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a high-level network architecture in accordance with an embodiment of the present technology;

FIG. 2 illustrates an example of a network topology in accordance with some embodiments of the present technology;

FIG. 3 illustrates a flow chart of the method for micro-segmentation using eBPF in accordance with some embodiments of the present technology; and

FIG. 4 illustrates an example network device in accordance with some embodiments of the present technology.

### DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

Systems, methods, and computer-readable media are provided for micro-segmentation without an intermediate firewall using an extended Berkeley Packet Filter (eBPF). An example method can include identifying one or more processes operating on a host network; assigning, by the host network, a process identity to each of the one or more processes operating on the host network; monitoring, by an eBPF, interactions between each of the one or more processes operating on the host network; identifying, by the eBPF, a source and a destination of the interactions between each of the one or more processes operating on the host network; determining, by the eBPF, a first process of the one or more processes operating on the host network does not interact with a second process of the one or more processes operating on the host network based on the source and the destination of the first process and the source and the destination of the second process; and blocking, by the eBPF, interactions between the first process and the second process on the host network.

In some examples, the techniques described herein relate to a method, further including: determining, by the eBPF, a third process of the one or more processes operating on the host network interacts with the second process based on the source and destination of the third process; and injecting, by the eBPF, a security control between the second process and the third process.

In some examples, the techniques described herein relate to a method, further including: identifying, by the eBPF, a query from the first process to the second process; determining, by the eBPF, the query from the first process to the second process is an attack based on the blocking of interactions between the first process and the second process; and blocking, by the host network, the query from the first process from interacting with the second process.

In some examples, the techniques described herein relate to a method, further including: identifying, by the host network, the IP five-tuple of the query; and blocking the IP five-tuple from further interacting with the host network.

In some examples, the techniques described herein relate to a method, wherein the host network is a single server.

In some examples, the techniques described herein relate to a method, wherein the host network is a virtual local area network (VLAN).

In some examples, the techniques described herein relate to a method, wherein the query includes an encrypted data packet.

An example system can include one or more processors and at least one computer-readable storage medium storing instructions which, when executed by the one or more processors, cause the one or more processors to identify one or more processes operating on a host network; assign, by the host network, a process identity to each of the one or more processes operating on the host network; monitor, by an extended Berkeley Packet Filter (eBPF), interactions between each of the one or more processes operating on the host network; identify, by the eBPF, a source and a destination of the interactions between each of the one or more processes operating on the host network; determine, by the eBPF, a first process of the one or more processes operating on the host network does not interact with a second process of the one or more processes operating on the host network based on the source and the destination of the first process and the source and the destination of the second process; and block, by the eBPF, interactions between the first process and the second process on the host network.

An example non-transitory computer-readable storage medium having stored therein instructions which, when executed by a processor, cause the processor to identify one or more processes operating on a host network; assign, by the host network, a process identity to each of the one or more processes operating on the host network; monitor, by an extended Berkeley Packet Filter (eBPF), interactions between each of the one or more processes operating on the host network; identify, by the eBPF, a source and a destination of the interactions between each of the one or more processes operating on the host network; determine, by the eBPF, a first process of the one or more processes operating on the host network does not interact with a second process of the one or more processes operating on the host network based on the source and the destination of the first process and the source and the destination of the second process; and block, by the eBPF, interactions between the first process and the second process on the host network.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As mentioned above, traditional micro-segmentation solutions require traffic to pass through an intermediate device (e.g., hypervisor, firewall, sidecar), and use the intermediate device to enforce east-west policies in terms of what VLANs or applications are allowed to communicate within the network. This type of micro-segmentation is effective when traversing across different hosts (e.g., server A to server B with networking in between). However, this type of micro-segmentation fails when the traffic never leaves the host or virtualization infrastructure.

To illustrate, if there are multiple processes on a single host or virtualization infrastructure and it is desired to allow process A to talk to process B and process B to talk to process C, but not allow process A to talk to process C, traditional micro-segmentation solutions fail. Additionally, this prevents additional security controls from being performed on communications between processes A, B, and C. While current systems may be able to provide intra-host or intra-process security measures by the use of the firewall or intermediate device, the current systems fail to prohibit certain inter-host or inter-process security measures.

The disclosed technology relates to providing micro-segmentation on traffic that never leaves the host or virtualization infrastructure using extended Berkeley Packet Filter (eBPF) technology instead of an intermediate device (e.g., a firewall). Thus, the present technology offers an advantage because it enables micro-segmentation between processes running on the same host or virtualization infrastructure, and can identify and intercept attacks occurring wholly within the host system.

The disclosed technology relies on eBPF (extended Berkeley Packet Filter) technology to monitor the inter-process communications, assign a process identity to the inter-processes, block specific inter-processes from communicating with each other, and insert security controls in between inter-processes that are allowed to communicate with each other. The concepts disclosed herein may assign a process identity to each process operating in a system (e.g., processes A, B, and C) and add eBPF monitoring to all of the inter-process communications occurring within the system (e.g., Transmission Control Protocol (TCP) and datagram connectivity between processes). The eBPF can determine the source and destination processes of calls and policies can be enacted to block certain processes from initiating and communicating with each other (e.g., processes A and C). When processes that are allowed to communicate with each other communicate (e.g., processes A and B or processes B and C), eBPF can inject security controls to ensure the safety of the communication and prevent lateral movement of an attacker, which prior to the techniques disclosed herein, is possible when every inter-process on a host network is allowed to communicate with each other.

The concepts disclosed herein enable each of the processes within the host system to be micro-segmented, such that the system can determine what inter-processes typically communicate and which inter-processes do not typically communicate. The system may enforce policies to block inter-processes that do not normally communicate from communicating. The system can determine which inter-processes typically do and do not communicate by using a set of eBPF tracepoints, kprobes, and other eBPF techniques to identify multiple datapoints about the processes and communications between the processes. Once each of the many datapoints are identified using the eBPF technology, then the system may map which inter-processes directly communicate (e.g., processes A and B), as well as which inter-processes do not communicate (e.g., processes A and C). In the example having processes A, B, and C, the system may enforce policies that permit inter-processes A and B to communicate, while enforcing policies to block communications between A and C. If an attacker is able to get into a host system and attempts to use process A to gain information from process C, the system will be able to identify that communication as an attack, and perform appropriate security measure.

These concepts can be illustrated through an example Structured Query Language (SQL) injection attack within a host network. In a SQL attack in a traditional micro-segmentation system, once the attacker is within the host system, an attacker may trigger an SQL query (e.g., “SELECT current_user”) to learn the information about the database (e.g., the database username). In traditional systems, since the attacker is already in the host system, the attacker will receive the information back he desires, and thus successfully attacked the system.

Using the technology disclosed herein, the system can inspect the SQL query that is being run (e.g., the “SELECT current_user” SQL injection attack to learn the database username), and see the incoming networking call that triggered the SQL query. In this example, curl calls coming in should only fetch configuration data in the normal course of operation. The system can see that an incoming curl call is requesting the database username instead of configuration data, and can infer that this may be an SQL injection attack. Using TCP tracing policies, the system may identify the IP five-tuple and/or the IP six-tuple (each tuple generally being one of: local process, local address, local port, protocol, remote address, remote port) of the actor which has triggered this curl call and inform policy enforcement points to block this IP address from further calls or, alternatively may trigger a honey pot by interception and spoofing of return values. The system can not only block these types of SQL injection attacks, but could also confuse the attacker by interception this and returning invalid data in response (e.g., trigger the honey pot). In examples where the IP six-tuple is identified, the system is able to identify the process information (e.g., the local process ID) using the eBPF technology, and may restrict processes from that specific IP six-tuple from communicating with other processes. It is appreciated that while the IP five-tuple or IP six-tuple of the actor may be identified in accordance with the concepts disclosed herein, the capability of the system to use eBPF to determine the local process information (e.g., local process ID), whether as part of the IP six-tuple or in addition to the IP five-tuple, enables the system to block processes from specific IPs.

Additionally, by utilizing the eBPF technology, the concepts disclosed herein are capable of identifying the source of the traffic (e.g., bad traffic in many cases) even if it is impossible to view inside the payload because the packets have been encrypted. Therefore, the present technology provides for inserting and intercepting those attacks (e.g., SQL injection attacks) and stopping the attacks from happening, even though the attacks happened inside an encrypted session.

As another example, consider a Kubernetes set up, where every node in the cluster is communicating with all the other nodes, and each host in the cluster has direct connection with other hosts in the cluster. In this example, while firewalls may be set up in the tunnels between each of the hosts in the cluster, workloads and communications within each host will not have the same level of protection provided by the firewalls. However, the micro-segmentation using eBPF technology disclosed herein enables micro-segmentation of the workloads and communications within each host of the Kubernetes cluster and can enforce security protocols or block communications between each workload.

Additionally, the technology disclosed herein enables micro-segmentation on the same host or virtualization infrastructure without the use of an intermediate device (e.g., firewall), thereby enabling security protocols to be enforced between inter-processes on the same host, as well as the separation of resources. Furthermore, micro-segmentation on the same host or virtualization infrastructure may also enable security protocols and separation of resources between inter-processes which interact with each other but may not directly communicate with each other. To illustrate in a non-limiting example, two processes on the same host may interact because one process wrote a record to a database, while a second process queried that record, however, those two processes do not directly communicate with each other. As another non-limiting example, two processes may not directly communicate, but interact with each other by virtue of sharing a common file between the processes. In these examples, the system, using the eBPF technology, may still identify multiple datapoints about the processes, including their process identities, and may allow or block these types of interactions from occurring using the same general techniques described herein. As such, while the above “A, B, and C processes” example discusses processes which directly communicate, the system may perform micro-segmentation to enforce security protocols and separation of resources between any inter-process interactions on the same host or virtualization infrastructure, regardless of how they interact.

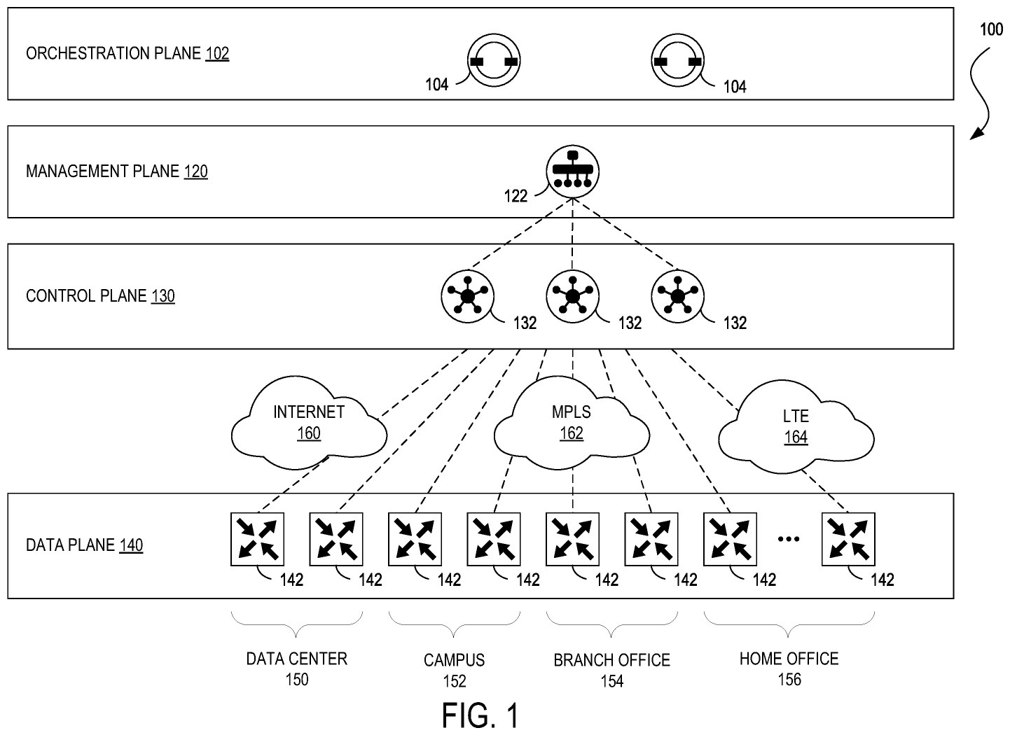

Turning to the figures, FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 120, a control plane 130, and a data plane 140. The orchestration plane can 102 assist in the automatic on-boarding of edge network devices 142 (e.g., switches, routers, etc.) in an overlay network. The orchestration plane 102 can include one or more physical or virtual network orchestrator appliances 104. The network orchestrator appliance(s) 104 can perform the initial authentication of the edge network devices 142 and orchestrate connectivity between devices of the control plane 130 and the data plane 140. In some embodiments, the network orchestrator appliance(s) 104 can also enable communication of devices located behind Network Address Translation (NAT). In some embodiments, physical or virtual Cisco® SD-WAN vBond appliances can operate as the network orchestrator appliance(s) 104.

The management plane 120 can be responsible for central configuration and monitoring of a network. The management plane 120 can include one or more physical or virtual network management appliances 122. In some embodiments, the network management appliance(s) 122 can provide centralized management of the network via a graphical user interface to enable a user to monitor, configure, and maintain the edge network devices 142 and links (e.g., Internet transport network 160, MPLS network 162, 4G/LTE network 164) in an underlay and overlay network. The network management appliance(s) 122 can support multi-tenancy and enable centralized management of logically isolated networks associated with different entities (e.g., enterprises, divisions within enterprises, groups within divisions, etc.). Alternatively or in addition, the network management appliance(s) 122 can be a dedicated network management system for a single entity. In some embodiments, physical or virtual Cisco® SD-WAN vManage appliances can operate as the network management appliance(s) 122.

The control plane 130 can build and maintain a network topology and make decisions on where traffic flows. The control plane 130 can include one or more physical or virtual network controller appliance(s) 132. The network controller appliance(s) 132 can establish secure connections to each network device 142 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network controller appliance(s) 132 can operate as route reflectors. The network controller appliance(s) 132 can also orchestrate secure connectivity in the data plane 140 between and among the edge network devices 142. For example, in some embodiments, the network controller appliance(s) 132 can distribute crypto key information among the network device(s) 142. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network controller appliance(s) 132.

The data plane 140 can be responsible for forwarding packets based on decisions from the control plane 130. The data plane 140 can include the edge network devices 142, which can be physical or virtual network devices. The edge network devices 142 can operate at the edges various network environments of an organization, such as in one or more data centers or colocation centers 150, campus networks 152, branch office networks 154, home office networks 154, and so forth, or in the cloud (e.g., Infrastructure as a Service (IaaS), Platform as a Service (PaaS), SaaS, and other cloud service provider networks). The edge network devices 142 can provide secure data plane connectivity among sites over one or more WAN transports, such as via one or more Internet transport networks 160 (e.g., Digital Subscriber Line (DSL), cable, etc.), MPLS networks 162 (or other private packet-switched network (e.g., Metro Ethernet, Frame Relay, Asynchronous Transfer Mode (ATM), etc.), mobile networks 164 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 142 can be responsible for traffic forwarding, security, encryption, quality of service (QOS), and routing (e.g., BGP, OSPF, etc.), among other tasks. In some embodiments, physical or virtual Cisco® SD-WAN vEdge routers can operate as the edge network devices 142.

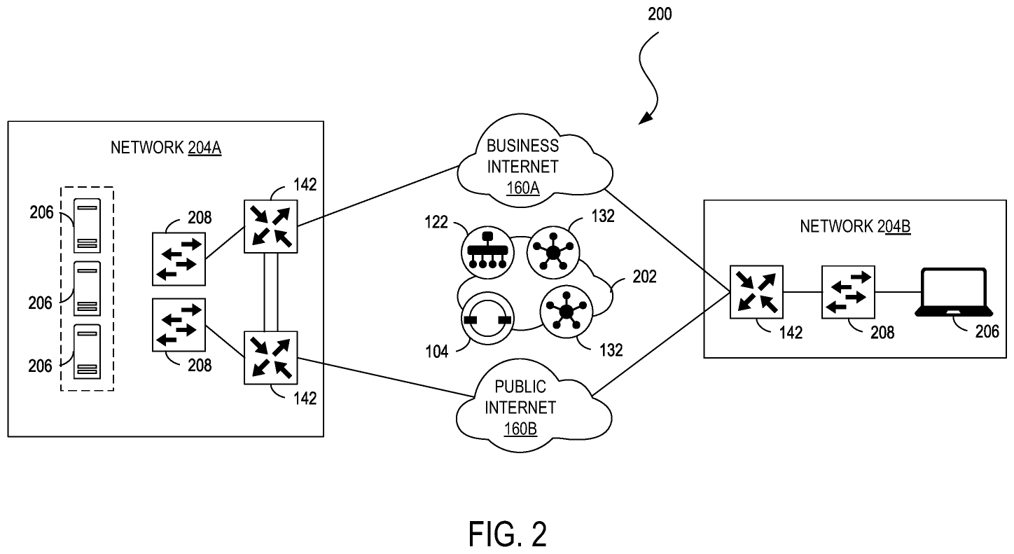

FIG. 2 illustrates an example of a network topology 200 for showing various aspects of the network architecture 100. The network topology 200 can include a management network 202, a pair of network sites 204A and 204B (e.g., the data center(s) 150, the campus network(s) 152, the branch office network(s) 154, the home office network(s) 156, cloud service provider network(s), etc.), and a pair of Internet transport networks 160A and 160B (collectively, 160). The management network 202 can include one or more network orchestrator appliances 104, one or more network management appliance 122, and one or more network controller appliances 132. Although the management network 202 is shown as a single network in this example, one of ordinary skill in the art will understand that each element of the management network 202 can be distributed across any number of networks and/or be co-located with the sites 204A, 204B. In this example, each element of the management network 202 can be reached through either transport network 160A or 160B.

Each site can include one or more endpoints 206 connected to one or more site network devices 208. The endpoints 206 can include general purpose computing devices (e.g., servers, workstations, desktop computers, etc.), mobile computing devices (e.g., laptops, tablets, mobile phones, etc.), wearable devices (e.g., watches, glasses or other head-mounted displays (HMDs), ear devices, etc.), and so forth. The endpoints 206 can also include Internet of Things (IoT) devices or equipment, such as agricultural equipment (e.g., livestock tracking and management systems, watering devices, unmanned aerial vehicles (UAVs), etc.); connected cars and other vehicles; smart home sensors and devices (e.g., alarm systems, security cameras, lighting, appliances, media players, HVAC equipment, utility meters, windows, automatic doors, door bells, locks, etc.); office equipment (e.g., desktop phones, copiers, fax machines, etc.); healthcare devices (e.g., pacemakers, biometric sensors, medical equipment, etc.); industrial equipment (e.g., robots, factory machinery, construction equipment, industrial sensors, etc.); retail equipment (e.g., vending machines, point of sale (POS) devices, Radio Frequency Identification (RFID) tags, etc.); smart city devices (e.g., street lamps, parking meters, waste management sensors, etc.); transportation and logistical equipment (e.g., turnstiles, rental car trackers, navigational devices, inventory monitors, etc.); and so forth.

The site network devices 208 can include physical or virtual switches, routers, and other network devices. Although the site 204A is shown including a pair of site network devices and the site 204B is shown including a single site network device in this example, the site network devices 208 can comprise any number of network devices in any network topology, including multi-tier (e.g., core, distribution, and access tiers), spine-and-leaf, mesh, tree, bus, hub and spoke, and so forth. For example, in some embodiments, one or more data center networks may implement the Cisco® Application Centric Infrastructure (ACI) architecture and/or one or more campus networks may implement the Cisco® Software Defined Access (SD-Access or SDA) architecture. The site network devices 208 can connect the endpoints 206 to one or more edge network devices 142, and the edge network devices 142 can be used to directly connect to the transport networks 160.

In some embodiments, “color” can be used to identify an individual WAN transport network, and different WAN transport networks may be assigned different colors (e.g., mpls, private1, biz-internet, metro-ethernet, lte, etc.). In this example, the network topology 200 can utilize a color called “biz-internet” for the Internet transport network 160A and a color called “public-internet” for the Internet transport network 160B.

In some embodiments, each edge network device 208 can form a Datagram Transport Layer Security (DTLS) or TLS control connection to the network controller appliance(s) 132 and connect to any network control appliance 132 over each transport network 160. In some embodiments, the edge network devices 142 can also securely connect to edge network devices in other sites via IPSec tunnels. In some embodiments, the BFD protocol may be used within each of these tunnels to detect loss, latency, jitter, and path failures.

On the edge network devices 142, color can be used help to identify or distinguish an individual WAN transport tunnel (e.g., no same color may be used twice on a single edge network device). Colors by themselves can also have significance. For example, the colors metro-ethernet, mpls, and private1, private2, private3, private4, private5, and private6 may be considered private colors, which can be used for private networks or in places where there is no NAT addressing of the transport IP endpoints (e.g., because there may be no NAT between two endpoints of the same color). When the edge network devices 142 use a private color, they may attempt to build IPSec tunnels to other edge network devices using native, private, underlay IP addresses. The public colors can include 3g, biz, internet, blue, bronze, custom1, custom2, custom3, default, gold, green, lte, public-internet, red, and silver. The public colors may be used by the edge network devices 142 to build tunnels to post-NAT IP addresses (if there is NAT involved). If the edge network devices 142 use private colors and need NAT to communicate to other private colors, the carrier setting in the configuration can dictate whether the edge network devices 142 use private or public IP addresses. Using this setting, two private colors can establish a session when one or both are using NAT.

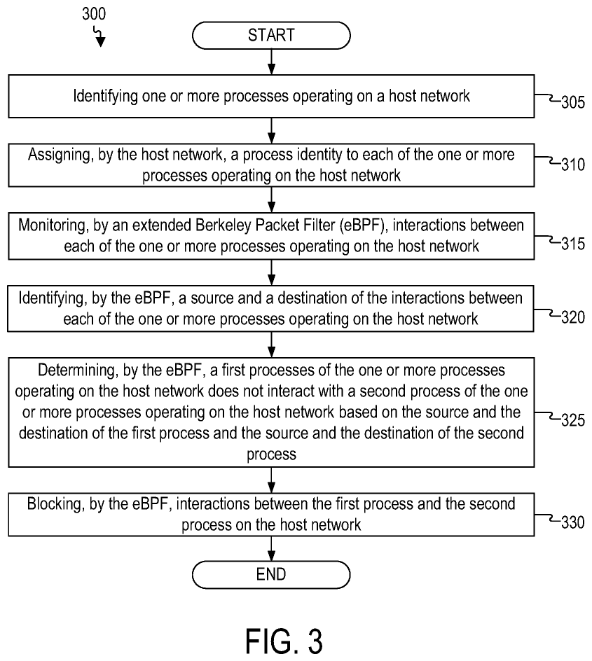

FIG. 3 illustrates an example method 300 for micro-segmentation without an intermediate firewall using eBPF. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, the method includes identifying one or more processes operating on a host network at block 305. For example, the management network 202 illustrated in FIG. 2 may identify one or more processes operating on the management network 202. In some examples, the host network may be a single server. In some examples, the host network is a virtual local area network (VLAN).

According to some examples, the method includes assigning, by the host network, a process identity to each of the one or more processes operating on the host network at block 310. For example, the management network 202 illustrated in FIG. 2 may assign a process identity to each of the one or more processes operating on the management network 202.

According to some examples, the method includes monitoring, by an extended Berkeley Packet Filter (eBPF), interactions between each of the one or more processes operating on the host network at block 315. For example, an eBPF that is part of the management network 202 illustrated in FIG. 2 may monitor interactions between each of the one or more processes operating on the management network 202.

According to some examples, the method includes identifying, by the eBPF, a source and a destination of the interactions between each of the one or more processes operating on the host network at block 320. For example, an eBPF that is part of the management network 202 illustrated in FIG. 2 may identify a source and a destination of the interactions between each of the one or more processes operating on the management network 202.

According to some examples, the method includes determining, by the eBPF, a first process of the one or more processes operating on the host network does not interact with a second process of the one or more processes operating on the host network based on the source and the destination of the first process and the source and the destination of the second process at block 325. For example, an eBPF that is part of the management network 202 illustrated in FIG. 2 may determine a first process of the one or more processes operating on the host network does not interact with a second process of the one or more processes operating on the host network based on the source and the destination of the first process and the source and the destination of the second process.

According to some examples, the method includes blocking, by the eBPF, interactions between the first process and the second process on the host network at block 330. For example, an eBPF that is part of the management network 202 illustrated in FIG. 2 may block interactions between the first process and the second process on the management network 202.

According to some examples, the method may further include determining, by the eBPF, a third process of the one or more processes operating on the host network interacts with the second process based on the source and destination of the third process. The method may further include injecting, by the eBPF, a security control between the second process and the third process. For example, an eBPF that is part of the management network 202 illustrated in FIG. 2 may determine a third process of the one or more processes operating on the host network interacts with the second process based on the source and destination of the third process, and inject a security control between the second process and the third process.

According to some examples, the method may further include identifying, by the eBPF, a query from the first process to the second process, determining, by the eBPF, the query from the first process to the second process is an attack based on the blocking of interactions between the first process and the second process; and blocking, by the host network, the query from the first process from interacting with the second process. For example, an eBPF that is part of the management network 202 illustrated in FIG. 2 may identify a query from the first process to the second process, determine the query from the first process to the second process is an attack based on the prior blocking of interactions between the first process and the second process. The management network 202 illustrated in FIG. 2 may then block the query from the first process from interacting with the second process. In some examples, the method may further include identifying, by the host network, the IP five-tuple of the query, and block the IP five-tuple from further interacting with the host network. In some examples, the query includes an encrypted data packet. In some examples, the method may further include identifying the IP six-tuple of the query, which may include the IP five-tuple as well as the process identities identified by the eBPF (e.g., local process), and block the IP six-tuple from further interacting with the host network.

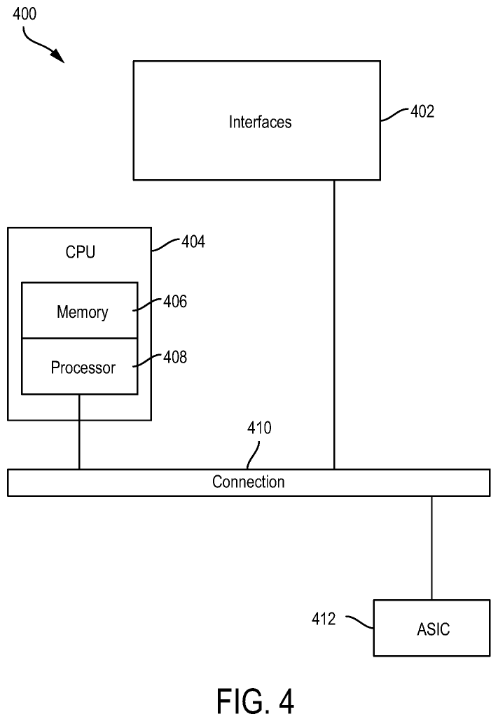

FIG. 4 illustrates an example network device 400 suitable for performing switching, routing, load balancing, and other networking operations. The example network device 400 can be implemented as switches, routers, nodes, metadata servers, load balancers, client devices, and so forth.

Network device 400 includes a central processing unit (CPU) 404, interfaces 402, and a bus 410 (e.g., a PCI bus). When acting under the control of appropriate software or firmware, the CPU 404 is responsible for executing packet management, error detection, and/or routing functions. The CPU 404 preferably accomplishes all these functions under the control of software including an operating system and any appropriate applications software. CPU 404 may include one or more processors 408, such as a processor from the INTEL X86 family of microprocessors. In some cases, processor 408 can be specially designed hardware for controlling the operations of network device 400. In some cases, a memory 406 (e.g., non-volatile RAM, ROM, etc.) also forms part of CPU 404. However, there are many different ways in which memory could be coupled to the system.

The interfaces 402 are typically provided as modular interface cards (sometimes referred to as “line cards”). Generally, they control the sending and receiving of data packets over the network and sometimes support other peripherals used with the network device 400. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LORA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communication intensive tasks, these interfaces allow the master CPU (e.g., 404) to efficiently perform routing computations, network diagnostics, security functions, etc.

Although the system shown in FIG. 4 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with the network device 400.

Regardless of the network device's configuration, it may employ one or more memories or memory modules (including memory 406) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 406 could also hold various software containers and virtualized execution environments and data.

The network device 400 can also include an application-specific integrated circuit (ASIC) 412, which can be configured to perform routing and/or switching operations. The ASIC 412 can communicate with other components in the network device 400 via the bus 410, to exchange data and signals and coordinate various types of operations by the network device 400, such as routing, switching, and/or data storage operations, for example.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Aspect 1. A method comprising: identifying one or more processes operating on a host network; assigning, by the host network, a process identity to each of the one or more processes operating on the host network; monitoring, by an extended Berkeley Packet Filter (eBPF), interactions between each of the one or more processes operating on the host network; identifying, by the eBPF, a source and a destination of the interactions between each of the one or more processes operating on the host network; determining, by the eBPF, a first process of the one or more processes operating on the host network does not interact with a second process of the one or more processes operating on the host network based on the source and the destination of the first process and the source and the destination of the second process; and blocking, by the eBPF, interactions between the first process and the second process on the host network.

Aspect 2. The method of aspect 1, further comprising: determining, by the eBPF, a third process of the one or more processes operating on the host network interacts with the second process based on a source and a destination of the third process; and injecting, by the eBPF, a security control between the second process and the third process.

Aspect 3. The method of any one of aspects 1-2, further comprising: identifying, by the eBPF, a query from the first process to the second process; determining, by the eBPF, the query from the first process to the second process is an attack based on the blocking of interactions between the first process and the second process; and blocking, by the host network, the query from the first process from interacting with the second process.

Aspect 4. The method of any one of aspects 1-3, further comprising: identifying, by the host network, an IP five-tuple of the query; and blocking the IP five-tuple from further interacting with the host network.

Aspect 5. The method of any one of aspects 1-4, wherein the host network is a single server.

Aspect 6. The method of any one of aspects 1-5, wherein the host network is a virtual local area network (VLAN).

Aspect 7. The method of any one of aspects 1-6, wherein the query includes an encrypted data packet.

Aspect 8. A system comprising: a storage configured to store instructions; and a processor configured to execute the instructions and cause the processor to: identify one or more processes operating on a host network; assign, by the host network, a process identity to each of the one or more processes operating on the host network; monitor, by an extended Berkeley Packet Filter (eBPF), interactions between each of the one or more processes operating on the host network; identify, by the eBPF, a source and a destination of the interactions between each of the one or more processes operating on the host network; determine, by the eBPF, a first process of the one or more processes operating on the host network does not interact with a second process of the one or more processes operating on the host network based on the source and the destination of the first process and the source and the destination of the second process; and block, by the eBPF, interactions between the first process and the second process on the host network.

Aspect 9. The system of aspect 8, further comprising: determining, by the eBPF, a third process of the one or more processes operating on the host network interacts with the second process based on a source and a destination of the third process; and injecting, by the eBPF, a security control between the second process and the third process.

Aspect 10. The system of any one of aspects 8-9, further comprising: identifying, by the eBPF, a query from the first process to the second process; determining, by the eBPF, the query from the first process to the second process is an attack based on the blocking of interactions between the first process and the second process; and blocking, by the host network, the query from the first process from interacting with the second process.

Aspect 11. The system of any one of aspects 8-10, further comprising: identifying, by the host network, an IP five-tuple of the query; and blocking the IP five-tuple from further interacting with the host network.

Aspect 12. The system of any one of aspects 8-11, wherein the host network is a single server.

Aspect 13. The system of any one of aspects 8-12, wherein the host network is a virtual local area network (VLAN).

Aspect 14. The system of any one of aspects 8-13, wherein the query includes an encrypted data packet.

Aspect 15. A non-transitory computer readable medium comprising instructions, the instructions, when executed by a computing system, cause the computing system to: identify one or more processes operating on a host network; assign, by the host network, a process identity to each of the one or more processes operating on the host network; monitor, by an extended Berkeley Packet Filter (eBPF), interactions between each of the one or more processes operating on the host network; identify, by the eBPF, a source and a destination of the interactions between each of the one or more processes operating on the host network; determine, by the eBPF, a first process of the one or more processes operating on the host network does not interact with a second process of the one or more processes operating on the host network based on the source and the destination of the first process and the source and the destination of the second process; and block, by the eBPF, interactions between the first process and the second process on the host network.

Aspect 16. The non-transitory computer readable medium of aspect 15, further comprising: determining, by the eBPF, a third process of the one or more processes operating on the host network interacts with the second process based on a source and a destination of the third process; and injecting, by the eBPF, a security control between the second process and the third process.

Aspect 17. The non-transitory computer readable medium of any one of aspects 15-16, further comprising: identifying, by the eBPF, a query from the first process to the second process; determining, by the eBPF, the query from the first process to the second process is an attack based on the blocking of interactions between the first process and the second process; and blocking, by the host network, the query from the first process from interacting with the second process.

Aspect 18. The non-transitory computer readable medium of any one of aspects 15-17, further comprising: identifying, by the host network, an IP five-tuple of the query; and blocking the IP five-tuple from further interacting with the host network.

Aspect 19. The non-transitory computer readable medium of any one of aspects 15-18, wherein the host network is a single server.

Aspect 20. The non-transitory computer readable medium of any one of aspects 15-19, wherein the host network is a virtual local area network (VLAN).

Aspect 21. The non-transitory computer readable medium of any one of aspects 15-20, wherein the query includes an encrypted data packet.

What is claimed is:

1. A method comprising:
identifying one or more processes operating on a host network;
assigning, by the host network, a process identity to each of the one or more processes operating on the host network;
monitoring, by an extended Berkeley Packet Filter (eBPF), interactions between each of the one or more processes operating on the host network;
identifying, by the eBPF, a source and a destination of the interactions between each of the one or more processes operating on the host network;
determining, by the eBPF, a first process of the one or more processes operating on the host network does not interact with a second process of the one or more processes operating on the host network based on the source and the destination of the first process and the source and the destination of the second process; and
blocking, by the eBPF, interactions between the first process and the second process on the host network.

2. The method of claim 1, further comprising:
determining, by the eBPF, a third process of the one or more processes operating on the host network interacts with the second process based on a source and a destination of the third process; and
injecting, by the eBPF, a security control between the second process and the third process.

3. The method of claim 1, further comprising:
identifying, by the eBPF, a query from the first process to the second process;
determining, by the eBPF, the query from the first process to the second process is an attack based on the blocking of interactions between the first process and the second process; and
blocking, by the host network, the query from the first process from interacting with the second process.

4. The method of claim 3, further comprising:
identifying, by the host network, an IP five-tuple of the query; and
blocking the IP five-tuple from further interacting with the host network.

5. The method of claim 3, wherein the query includes an encrypted data packet.

6. The method of claim 1, wherein the host network is a single server.

7. The method of claim 1, wherein the host network is a virtual local area network (VLAN).

8. A system comprising:
a storage configured to store instructions; and
a processor configured to execute the instructions and cause the processor to:
identify one or more processes operating on a host network;
assign, by the host network, a process identity to each of the one or more processes operating on the host network;
monitor, by an extended Berkeley Packet Filter (eBPF), interactions between each of the one or more processes operating on the host network;
identify, by the eBPF, a source and a destination of the interactions between each of the one or more processes operating on the host network;
determine, by the eBPF, a first process of the one or more processes operating on the host network does not interact with a second process of the one or more processes operating on the host network based on the source and the destination of the first process and the source and the destination of the second process; and
block, by the eBPF, interactions between the first process and the second process on the host network.

9. The system of claim 8, further comprising:
determining, by the eBPF, a third process of the one or more processes operating on the host network interacts with the second process based on a source and a destination of the third process; and
injecting, by the eBPF, a security control between the second process and the third process.

10. The system of claim 8, further comprising:
identifying, by the eBPF, a query from the first process to the second process;
determining, by the eBPF, the query from the first process to the second process is an attack based on the blocking of interactions between the first process and the second process; and
blocking, by the host network, the query from the first process from interacting with the second process.

11. The system of claim 10, further comprising:
identifying, by the host network, an IP five-tuple of the query; and
blocking the IP five-tuple from further interacting with the host network.

12. The system of claim 10, wherein the query includes an encrypted data packet.

13. The system of claim 8, wherein the host network is a single server.

14. The system of claim 8, wherein the host network is a virtual local area network (VLAN).

15. A non-transitory computer readable medium comprising instructions, the instructions, when executed by a computing system, cause the computing system to:
identify one or more processes operating on a host network;
assign, by the host network, a process identity to each of the one or more processes operating on the host network;
monitor, by an extended Berkeley Packet Filter (eBPF), interactions between each of the one or more processes operating on the host network;
identify, by the eBPF, a source and a destination of the interactions between each of the one or more processes operating on the host network;
determine, by the eBPF, a first process of the one or more processes operating on the host network does not interact with a second process of the one or more processes operating on the host network based on the source and the destination of the first process and the source and the destination of the second process; and
block, by the eBPF, interactions between the first process and the second process on the host network.

16. The non-transitory computer readable medium of claim 15, further comprising:
determining, by the eBPF, a third process of the one or more processes operating on the host network interacts with the second process based on a source and a destination of the third process; and
injecting, by the eBPF, a security control between the second process and the third process.

17. The non-transitory computer readable medium of claim 15, further comprising:
identifying, by the eBPF, a query from the first process to the second process;
determining, by the eBPF, the query from the first process to the second process is an attack based on the blocking of interactions between the first process and the second process; and
blocking, by the host network, the query from the first process from interacting with the second process.

18. The non-transitory computer readable medium of claim 17, further comprising:
identifying, by the host network, an IP five-tuple of the query; and
blocking the IP five-tuple from further interacting with the host network.

19. The non-transitory computer readable medium of claim 15, wherein the host network is a single server.

20. The non-transitory computer readable medium of claim 15, wherein the host network is a virtual local area network (VLAN).
